(19) United States
(12) Patent Application Publication
(10) Pub. No.: US 2002/0131206 A1
(43) Pub. Date: Sep. 19, 2002

(54) Pancake made up of media in strip or tape form with an identification coding and process for production thereof

(75) Inventor: Bernd Scholtysik, Muenchen (DE)

Correspondence Address: GREENBLUM & BERNSTEIN, P.L.C., 1941 ROLAND CLARKE PLACE, RESTON, VA, 20191, US

(73) Assignee: EMTEC MAGNETICS GmbH, Ludwigshafen (DE)

(21) Appl. No.: 10/096,927

(22) Filed: Mar. 14, 2002

(30) Foreign Application Priority Data
Mar. 15, 2001 (DE) 101 12 391.4

(51) Int. Cl. B65H 69/00; B65H 69/06; B65H 81/06; B65H 19/18; B65H 19/00; G11B 5/78; G11B 23/00

(52) U.S. Cl. 360/131; 360/134; 242/324; 242/430; 242/551; 242/556

(57) ABSTRACT

Pancake of media in strip or tape form and method of making the pancake, the pancake including a hub onto which the media is wound until an outer wound layer is formed on the pancake, and a sealing element attached to the outer wound layer of the pancake such that a free end of the outer wound layer of the pancake is formed in a region beneath the sealing element. The process provides for winding the media onto a hub and attaching a sealing element to an outer layer of the media, wherein the sealing element is attached to the outer wound layer of the pancake such that a free end of the outer wound layer of the pancake is formed in a region beneath the sealing element.

### CROSS-REFERENCE TO RELATED APPLICATIONS

The present application claims priority under 35 U.S.C. §119 of German Patent Application No. 101 12 391.4, filed on Mar. 15, 2001, the disclosure of which is expressly incorporated by reference herein in its entirety.

### BACKGROUND OF THE INVENTION

1. Field of the Invention

The invention relates to a pancake made up of media in strip or tape form that uses an identification coding, and in particular relates to a pancake having magnetic data recording media in tape form.

2. Discussion of Background Information

So-called pancakes are rolls of media which are arranged in strip or tape form. Pancakes of magnetic recording media in tape form generally comprise magnetic tape which is several thousands of meters in length and which has been slit to a usable width and wound up on a hub. A sealing adhesive strip fixes the free end of the magnetic tape on the outermost layer of the pancake. A label which comprises at least a product coding is also attached to the pancake.

The magnetic data recording medium substantially comprises a base film of plastic and a magnetizable coating applied to it. The medium is generally produced in widths which are much greater than the width necessary for a particular application. The coating is a liquid magnetic dispersion that is applied to the base film by means of coating devices which are known to a person skilled in the art. The coated film then runs through a drying process and then it is typically calendered. Finally, it is rolled up into so-called semifinished rolls whose length is many times the useful length of an assembled finished product.

After the coating, the semifinished roll of tape medium is subjected to slitting in order to produce usable tape widths, such as, e.g., 1/2″ for VHS cassettes. This slitting takes place in so-called slitting or cutting machines.

As shown in FIG. 1, such cutting machines substantially comprise an unrolling station 100 for unrolling the semifinished rolls HFR. A first guide roll 600 guides the medium to a cutting table 200. The cutting table is used for joining the end of one semifinished roll HF1 to the beginning of a following semifinished roll HF2. The first guide roll 600 and a second guide roll 600′ support the medium over the cutting table 200. A slitting unit 300 is used to slit the medium into the desired widths. A third guide roll 600″ is used to guide the tapes to a spreader 400. The tape spreader 400 is used for individually separating the tapes cut to the usable width. A winding-up station 500 is provided for winding up the individual tapes cut to the usable width. The rolls 600, 600′ and 600″ are guiding and driving rollers which both guide and transport the uncut semifinished web HF, as well as the separate individual tapes EB between the individual stations of the machine. To reduce unproductive time which occurs during the changing of the semifinished rolls, the unrolling station 100 may be provided with two winders, into which the just-cut semifinished roll HF1 and the next-cut semifinished roll HF2 can be fixed.

FIG. 2 shows a prior art pancake 1 in which a sealing adhesive strip 3 is applied in its original form as an elongate adhesive strip (not shown). The strip 3 extends transversely over the width of the semifinished product to be cut, i.e., HF1 and HF2 (not shown). During the changing of the semifinished rolls, the sealing strip 3 is applied at the cutting table 200 in order to join the end of the semifinished web HF1 with the beginning of the following semifinished web HF2. Subsequently, the joint produced by means of the aforementioned elongate adhesive strip 3 between the end of the tape of one semifinished roll HF1 and the beginning of the then following semifinished roll HF2 runs through the slitting unit 300. Then, the slit tape passes via the tape spreader 400 to the winding-up station 500. At the wind-up station 500, the adhesive strip 3 automatically seals the pancake 1, i.e., fixes the end of the outer wound layer 1.2 to the pancake. A beginning 2 of the individual tapes is cut from the then-following semifinished roll HF2, and is subsequently cut off transversely a few centimeters downstream of the joint. FIG. 2 shows the pancake 1 that is finally obtained. As can be seen, the left side of the adhesive strip 3 is fixed to the end of the outer wound layer 1.2, a middle portion 3.1 defines a sticky region of the adhesive strip 3 which is fixed to outer tape layer of the roll 1.1, and the right side of the adhesive strip is fixed to a short portion 2 of tape.

The joint between the end of the web of one semifinished roll HF1 and the beginning of the web of the then-following semifinished roll HF2 is made in the form of a so-called “open splice”. This means that a gap “g” a few millimeters wide is created between the end of the one semifinished roll HF1 and the beginning of the then-following semifinished roll HF2. This gap “g” defines a sticky region 3.1 which serves to seal the pancake 1, i.e., it prevents the tape of the pancake 1 from unwinding.

As shown in FIG. 2, the pancake 1 includes a roll 1.1 that is wound onto a hub 5 and is usually also provided with an identification coding 4. This coding will contain product-specific data for the pancake 1. The identification coding 4 is generally provided on an additional label 4.1 which is attached, by means of narrow adhesive strips 4.3 and 4.4, on the last outer wound layer 1.2 of the pancake 1. The printing 4.2 of the additional label 4.1 that defines the product-specific data is in the form of either plain text and/or as a barcode.

During further processing of the pancakes 1, such as for example reeling them into cassettes, or in transferring audio or video recordings onto entire pancakes 1 in duplicating installations, the pancakes 1 must typically be opened again. This opening requires the removal of the identification coding 4 which has proven to be inconvenient. Moreover, since at least the two end regions of the label 4.1 are securely joined by means of the adhesive strips 4.3 and 4.4 to the outer layer 1.2 of the roll 1. 1, it is difficult to detach the label 4.1 and strips 4.3 and 4.4 from the outer layer 1.2 of the roll 1.1.

It is also necessary, as part of quality assurance procedures, for the individual pancakes 1 to be opened in order to be able to check and document data relevant to quality. In order to create a pancake 1 that is ready for sale again after it has been checked, the pancake has to be properly sealed again with the sealing adhesive strip 3, and the identification coding 4 also has to be re-attached.

The above-noted prior art handling has proven to be an inconvenient procedure, since both the opening and the sealing of the pancake require a two-part operation, i.e., that is, separate removal of the sealing adhesive strip 3 and of the identification coding 4 when the pancake 1 is opened, and separate attachment of the sealing adhesive strip 3 and the identification coding 4 when the pancake 1 is sealed.

### SUMMARY OF THE INVENTION

The invention therefore provides for a pancake of media in strip or tape form, in particular magnetic data recording media, that does not have the disadvantages of the prior art, and consequently reduces considerably the effort involved in opening and sealing the pancake. The invention also provides for a process for the production of such a pancake.

The invention provides a pancake that is made up of media in strip or tape form, in particular magnetic data recording media, in which the pancake includes a hub with data recording media in strip or tape form wound up on it. The pancake is sealed by a sealing element which combines the function of a sealing adhesive strip and an identification coding. The sealing element is attached to the outer wound layer of the pancake in such a way that a free end of the outer wound layer of the pancake is formed in the region beneath the coding portion.

The invention also provides a process for the production of a pancake that is made up of media in strip or tape form, in particular magnetic data recording media, in which a hub with data recording media in strip or tape form is wound up on it and a sealing element is used. The sealing element is formed by a joint between the end of a first semifinished web and the beginning of a further semifinished web, while they are spaced apart from each other. The joint runs through the slitting unit of a slitting machine and includes two adhesive strips and a label strip. The label strip overlaps the end of the first semifinished web in a region X, and in this way, creates a free end of the first semifinished web.

The invention also provides for a pancake that is made up of media in strip or tape form, that includes a hub onto which the media is wound until an outer wound layer is formed on the pancake, and a sealing element attached to the outer wound layer of the pancake such that a free end of the outer wound layer of the pancake is formed in a region beneath the sealing element.

The media may comprise magnetic data recording media in tape form. The sealing element may comprise a coding portion. The sealing element may be attached to the outer wound layer of the pancake such that a free end of the outer wound layer of the pancake is formed in a region beneath the coding portion. The sealing element may comprise at least a first adhesive strip portion and at least a second adhesive strip portion. The sealing element may further include a coding label portion arranged between the first and second adhesive strip portions. The first adhesive strip portion may overlap a free end of the coding label portion and the second adhesive strip portion may overlap another free end of the coding label portion. The first adhesive strip portion may overlap a free end of the coding label portion by an amount Y and the second adhesive strip portion may overlap another free end of the coding label portion by an amount Z1. The amount Y may be in the range of between approximately 5 mm and approximately 10 mm and the amount Z1 may be in the range of between approximately 5 mm and approximately 10 mm.

The invention also provides for a process for the production of a pancake that is made up of media in strip or tape form, wherein the process includes winding the media onto a hub, and attaching a sealing element to an outer layer of the media, wherein the sealing element is attached to the outer wound layer of the pancake such that a free end of the outer wound layer of the pancake is formed in a region beneath the sealing element.

The process may further include slitting a web of media to form a plurality of individual media strips. The process may further include cutting the web transversely to form a trailing end, and forming a joint between a beginning end of another web and the trailing end. The process may further include maintaining a space or distance A between the beginning end of another web and the trailing end. The process may further include guiding the joint along with the beginning end of another web and the trailing end through a slitting unit of a slitting machine. The process may further include slitting the joint along with the beginning end of another web and the trailing end in a slitting unit of a slitting machine. The attaching may further include attaching a first end of the sealing element to the free end. The attaching may further include attaching a second end of the sealing element to another portion of the outer layer. The process may further include forming another free end and attaching the other free end to the sealing element. The process may further include removing the sealing element from the pancake and reattaching the sealing element to the pancake.

The invention still further provides for a pancake that is made up of media in strip or tape form, that includes a roll of media that is wound to form an outer wound layer and a sealing element attached to the outer wound layer such that a free end of the outer wound layer is formed in a region beneath the sealing element.

The invention also contemplates a process for the production of a pancake that is made up of media in strip or tape form, the process including unwinding a first web of media, guiding the first web of media over a cutting table, connecting a trailing end of the first web of media to a beginning end of a second web of media to form a joint, slitting the first and second webs and the joint in a slitting machine to form a plurality of individual strips, and winding at least one of the plurality of strips to form the pancake, wherein the sealing element is attached to the outer wound layer of the pancake such that a free end of the outer wound layer of the pancake is formed in a region beneath the sealing element.

Before winding, the process may further include spreading the plurality of strips in a spreader. Before slitting, the process may further include securing to the cutting table at least the trailing end of the first web of media. Before slitting, the process may further include securing to the cutting table the trailing end of the first web of media and the beginning end of the second web of media.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic representation of a prior art slitting or cutting machine;

FIG. 2 shows a schematic representation of a pancake according to the prior art;

FIG. 3 shows a schematic representation of a pancake according to the invention;

FIG. 4 shows a schematic plan view of a cutting table; and

FIG. 5 shows a side view of the arrangement according to FIG. 4.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

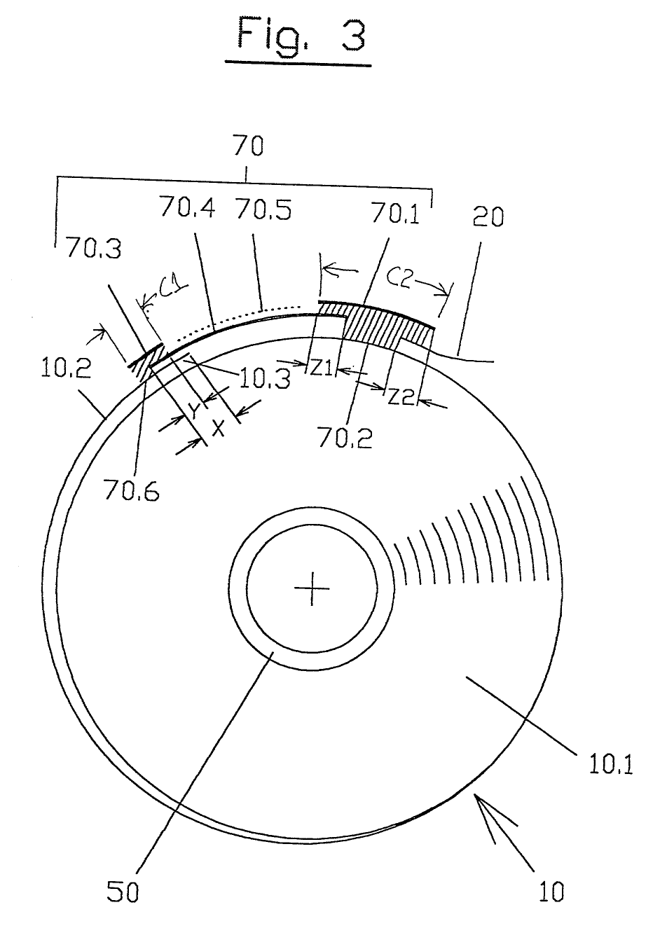

With reference to FIG. 3, it can be seen that a pancake 10 is formed by a roll 10.1 of tape that is wound onto a hub 50. The outer wound layer 10.2 of the tape is sealed and coded with a sealing element 70 according to the invention. The width of an individual sealing element 70 corresponds to the width of the wound-up data recording medium, e.g., the width of the tape.

The individual sealing element 70 substantially includes at least two single-sided adhesive strip portions 70.1 and 70.3, and a coding label portion 70.4 which is arranged in between. Each adhesive strip portion 70.1 and 70.3 has a portion that overlaps a free end of the coding label portion 70.4, i.e., a right side of the strip 70.3 overlaps a left side of label 70.4 by an amount Y, and a left side of the strip 70.1 overlaps a right side of label 70.4 by an amount Z1. The sealing element 70 is attached on the outer wound layer 10.2 of the roll 10.1 in such a way that a free end 10.3 of the outer wound layer 10.2 having a length (i.e., an amount X) of several centimeters is formed.

In the case of a magnetic data type recording medium, the following lengths (circumferential lengths measured from left side to right side) may be utilized: approximately 30 mm for the adhesive strip portion 70.1, approximately 20 mm for the adhesive strip portion 70.3, and approximately 100 mm for the coding label portion 70.4, since these lengths have proven to be favorable. Amounts that may be used for the overlapping of the adhesive strip portions 70.1 and 70.3, and the coding label portion 70.4, can be between approximately 5 mm and approximately 10 mm, i.e., lengths Y and Z1 can be between approximately 5 mm and approximately 10 mm.

As can be seen in FIG. 3, the left side portion (equal to length C1−Y) of strip 70.3 has a sticky region 70.6 that attaches to the outer wound layer 10.2 of the roll 10.1. Moreover, strip 70.1 similarly has an overlap portion (equal to length Z1). Strip 70.1 also has a sticky region 70.2 (equal to length C2−(Z1+Z2)), except that it is arranged in a middle portion of the strip 70.1. This region 70.2 also attaches to the outer wound layer 10.2 of the roll 10.1. The strip 70.1 further includes a right side portion (equal to length Z2) to which a trailing end of free end 20 attaches.

The special advantage of the sealing element 70 according to the invention is that inexpensive and/or commercially available starting materials in strip form can be utilized. These can also be supplied in the form of roll stock, so that it is possible to dispense with expensive customized materials, strips and/or labels.

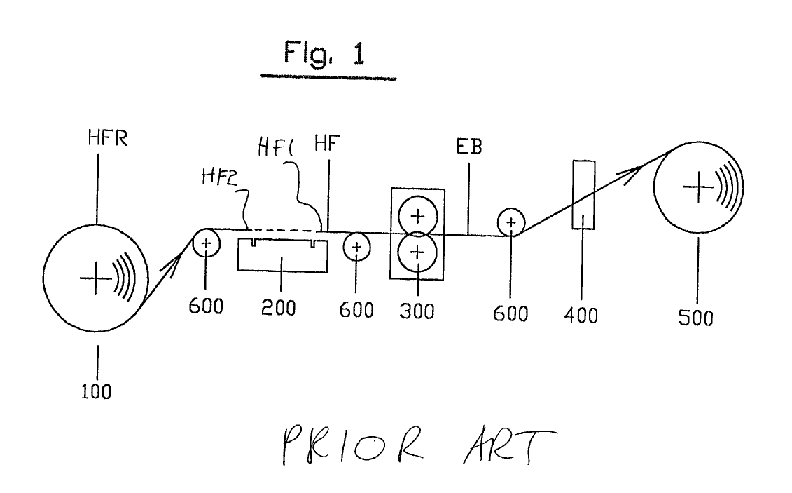

A process for the production of a pancake 10 according to the invention will now described with reference to FIGS. 1, 3 and 5.

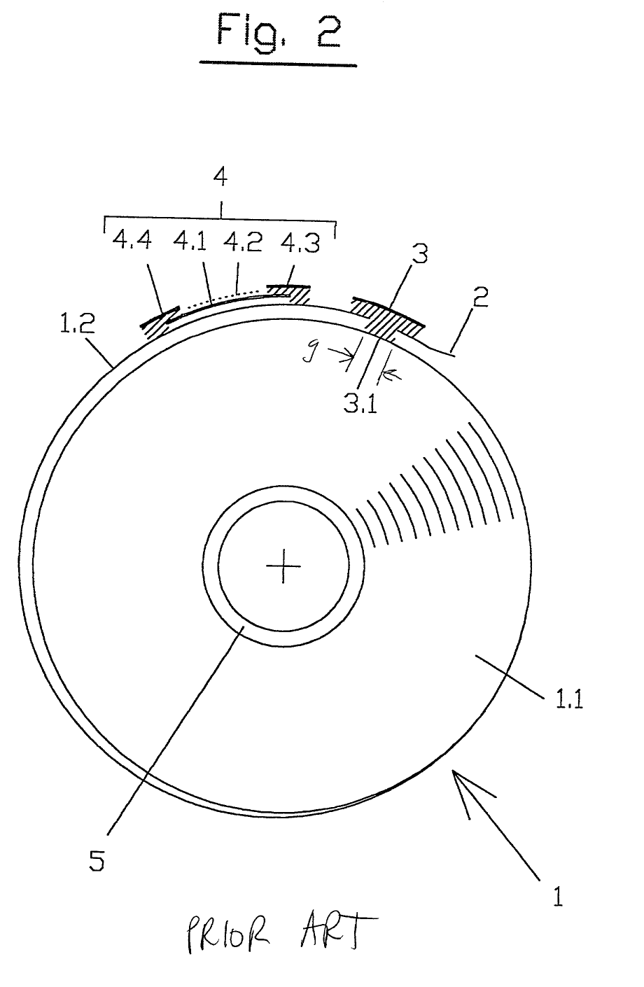

As shown in FIG. 1, a first semifinished roll HFR, which is stored in the unrolling station 100, is unrolled and allowed to pass by way of guide rollers 600 and 600′ over the cutting table 200. As can be seen, this is accomplished initially without contact between the web HF and the table 200. The web HF then passes from there into the slitting unit 300 which longitudinally slits the semifinished product HF1 into individual tapes EB of the desired width. After passing the slitting unit 300, the individual tapes EB guided by a roller 600″ to a spreader 400 which causes the tapes EP to be fanned out and/or spread apart. The individual tapes EB are then fed to a winding-up station 500 whereupon the individual tapes are wound onto hubs 50 (see FIG. 2) to form pancakes 10. In this way, pancakes 10 having several thousands of meters in length of tape can be obtained.

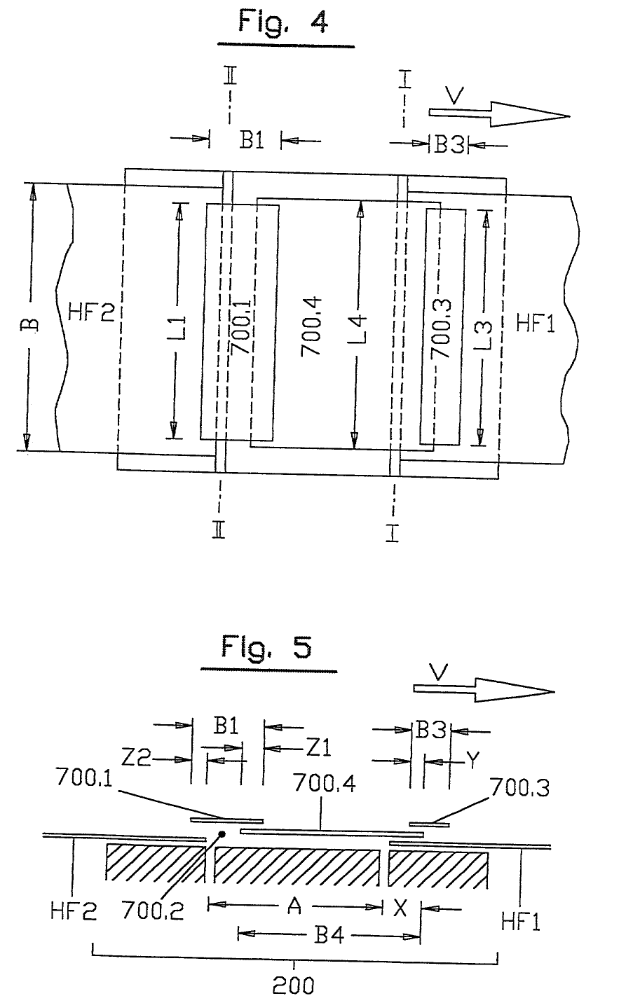

Once the first semifinished roll HFR stored in the unrolling station 100 has been almost completely cut up, the cutting machine is brought to a standstill and/or stopped. The web tension between the unrolling station 100 and the slitting unit 300 is then reduced and/or slackened. Then, the semifinished web HF is lowered onto the cutting table 200. The cutting table 200 has a porous surface (not shown) to which a vacuum can be applied from the underside of the table 200 (not shown). The semifinished web HF coming from the unrolling station 100 is then caused to be fixed and/or retained on the cutting table 200. Thereafter, the semifinished web HF is cut off along the line I-I (see FIG. 4) transversely to the web running direction V. This causes a trailing end to be formed in the semifinished web HF1 (see FIG. 5). Then, the remaining amount of web from cut line I-I back to the unrolling station 100 is pulled off the cutting table 200 so that the remaining amount of the first semifinished roll HFR can be removed from the unrolling station 100. At this point, only the trailing end of the web HF1 is retained on the table 200.

A second of further semifinished roll HFR which is to be cut is placed into the unrolling station 100 and the beginning of the semifinished web HF2 is brought up to the cutting table 200 where it is fixed and/or secured thereto by way of the still applied vacuum. Next, the beginning of web HF2 is cut off along the line II-II in a manner transversely to the running direction V of the web. Then the cut-off portion (not shown) of the beginning of the semifinished web HF2 is removed from the cutting table 200. As can be seen in FIG. 5, this leaves the trailing end of the semifinished web HF1 and the beginning of the semifinished web HF2 spaced apart from each other by the amount A. The amount A is made to approximately match the width B4 of a label strip 700.4.

With the completion of the slitting operation of the first semifinished roll, the label 700.4 can then be created and attached. The label 700.4 is formed using the compiled product-specific data which is transferred onto the label strip 700.4 by way of a printer. The length L4 (see FIG. 4) of the label strip 700.4 corresponds approximately to the width B of the semifinished webs HF1 and HF2 which will be cut up later on. The width B4 of the label strip 700.4 is made to substantially and/or approximately match the length of the printing 70.5 (see FIG. 3) plus the necessary overlaps Z1 and Y with the two adhesive strips 700.1 and 700.3. A plastic film, such as, e.g., PET, and/or a paper are suitable as the starting material for the label strip 700.4 which is to be printed on. However, other label strip materials, whether conventional or otherwise, may also be utilized. The printing (not shown) of the label strip 700.4 can takes place by the usual methods, such as, e.g., by needle or thermal transfer printing. However, other printing techniques, whether conventional or otherwise, may also be utilized. The printing is applied perpendicularly to the length L4 of the label strip 700.4 and the line spacing (not shown) of the printing is made to match the desired width of the cut individual tapes EB. The adhesive strips 700.1 and 700.3 can be made from commercially available single-sided adhesive roll stock. However, other strip materials, whether conventional or otherwise, may also be utilized. Adhesive strips 700.1 and 700.3 of different widths B1 and B3 can be used as shown in FIGS. 4 and 5. Moreover, these adhesive strips 700.1 and 700.3 can have different colors for easier differentiation. These colored adhesive strips may also be used for grade-specific coding of the pancakes.

Once the beginning end of the semifinished web HF2 and the trailing end of the semifinished web HF1 have been fixed and/or secured on the cutting table 200 as described above, the label strip 700.4 having been provided with the printing 70.5 is removed from the printer and placed onto the free region between the two semifinished webs HF1 and HF2, in such a way that the label strip 700.4 overlaps the trailing end of the semifinished web HF1 in the region X. This attachment of label 700.4 to the trailing end of web HF1 defines a free end of the first semifinished web HF1. Since the vacuum is still being applied to the cutting table 200, this has the effect of causing the label strip 700.4 to also be fixed and/or retained in its position.

Then, the two adhesive strips 700.1 and 700.3 are adhesively attached. As can be seen in FIG. 4, each strip 700.1 and 700.3 is attached transversely to the web running direction V in such a way that between the adhesive strip 700.3 and the label strip 700.4 there is formed an overlap in the region Y (see FIG. 5). Another overlap region (defined by distance Z2) is formed between the adhesive strip 700.1 and the beginning of the semifinished web HF2. Still, further another overlap region (defined by distance Z1) is formed between the adhesive strip 700.1 and the label strip 700.4.

A distance between the forward end of the beginning of the semifinished web HF2 and a rear end of the label strip 700.4 is defined as a sticky region 700.2. The width B1 of the adhesive strip 700.1 corresponds to the sum of the widths of the overlaps in the regions Z1 and Z2, plus the width of the sticky region 700.2. The width or distance A defines the “open splice”.

The width B3 of the adhesive strip 700.3 is dimensioned such that, in addition to the overlap in the region Y, an adequate adhesive joint is also obtained with respect to the first semifinished web HF1 (defined by a distance B3−Y). As can be seen in FIG. 4, the lengths L1 and L3 of the adhesive strips 700.1 and 700.3 correspond approximately to the length L4 of the label strip 700.4.

Once the two semifinished webs HF1 and HF2 have been securely joined to each other by the combination of strips 700.1, 700.3, and label 700.4, the vacuum that is applied to the cutting table 200 can be switched off. Next, the connected web is tensioned to raise the web above the table 200 (see FIG. 1) and the cutting machine is started again. When the joint which was made between the two semifinished webs HF1 and HF2 and which is spaced apart from each other by the amount A, passes through the slitting unit 300, the joint is also correspondingly longitudinally cut up and the individual sealing elements 70 are created. With the arrival of the so-called “open splice” at the circumference of the pancakes 10 that occurs in the winding-up station, the pancakes 10 can be automatically sealed, resulting in the pancake configuration shown in FIG. 3.

Although not shown, a few centimeters after the open splice, the individual tapes EB can be cut from the semifinished web HF2, i.e., cut off transversely, so that each individual tape EB has a free end portion 20. This free end 20 is cut from the beginning end portion of the semifinished web HF2 and remains on each pancake 10, as shown in FIG. 3.

By producing the pancake 10 in this way, the pancake 10 can be easily opened and sealed again. When it is necessary to open or unseal the pancake 10, one merely pulls on the free end 20 radially outwards and/or away from the circumference of the pancake 10. This results in the sealing element 70 being detached from the outer layer 10.2 of the pancake 10, i.e., the sticky region 70.2 is detached and/or separated from outer layer 10.2. By further radial pulling on the free end 20 in the same direction, while at the same time securely holding the free end 10.3 of the outer layer 10.2 of the pancake 10, one can entirely remove the sealing element 70 from the pancake 10, i.e., when the sticky region 70.6 of the adhesive strip 70.3 is likewise detached from the outer layer 10.2, the sealing element 70 will be completely removed from the pancake 10.

On the other hand, the configuration shown in FIG. 3 allows for the pancake 10 to be easily sealed again with the sealing element 70, i.e., either by using the sealing element 70 which was removed or by using a new sealing element 70. In installing the sealing element 70 onto the pancake 10, the sealing element 70 is firstly fixed and/or attached to the outer layer 10.2 via the adhesive or sticky region 70.6 of the adhesive strip 70.3, as shown in FIG. 3. A free end 10.3 of length X is thereby created. Then, the free end 20 which is already attached and/or adhering to the sealing element 70, is pulled and/or manipulated until the sealing is complete. In this regard, the free end 20 can be pulled at first tangentially with respect to the circumference of the pancake 10, and then the adhesive strip 70.1 can be pressed against the outer layer 10.2 of the pancake 10. This will cause the sticky region 70.2 of the adhesive strip 70.1 which forms the open splice to be re-sealed and/or re-attached attached to the pancake 10. When the sealing is complete, the pancake 10 will have the configuration shown in FIG. 3.

It should be noted that the invention described above is not limited to pancakes formed of magnetic data recording media, but can also be practiced advantageously with any type of other media in strip or tape form, and/or whether or not such media is provided with recording and functional layers.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A pancake of media in strip or tape form, comprising:
a hub onto which the media is wound until an outer wound layer is formed on the pancake; and
a sealing element attached to the outer wound layer of the pancake such that a free end of the outer wound layer of the pancake is formed in a region beneath the sealing element.

2. The pancake of claim 1, wherein the media comprises magnetic data recording media in tape form.

3. The pancake of claim 1, wherein the sealing element comprises a coding portion.

4. The pancake of claim 3, wherein the sealing element is attached to the outer wound layer of the pancake such that a free end of the outer wound layer of the pancake is formed in a region beneath the coding portion.

5. The pancake of claim 1, wherein the sealing element comprises at least a first adhesive strip portion and at least a second adhesive strip portion.

6. The pancake of claim 5, wherein the sealing element further comprises a coding label portion arranged between the first and second adhesive strip portions.

7. The pancake of claim 6, wherein the first adhesive strip portion overlaps a free end of the coding label portion and wherein the second adhesive strip portion overlaps another free end of the coding label portion.

8. The pancake of claim 6, wherein the first adhesive strip portion overlaps a free end of the coding label portion by an amount Y and wherein the second adhesive strip portion overlaps another free end of the coding label portion by an amount Z1.

9. The pancake of claim 8, wherein the amount Y is in the range of between approximately 5 mm and approximately 10 mm and wherein the amount Z1 is in the range of between approximately 5 mm and approximately 10 mm.

10. A process for the production of a pancake of media in strip or tape form, the process comprising:
winding the media onto a hub; and
attaching a sealing element to an outer layer of the media,
wherein the sealing element is attached to the outer wound layer of the pancake such that a free end of the outer wound layer of the pancake is formed in a region beneath the sealing element.

11. The process of claim 10, further comprising:
slitting a web of media to form a plurality of individual media strips.

12. The process of claim 11, further comprising:
cutting the web transversely to form a trailing end; and
forming a joint between a beginning end of another web and the trailing end.

13. The process of claim 12, further comprising:
maintaining a space or distance A between the beginning end of another web and the trailing end.

14. The process of claim 13, further comprising:
guiding the joint along with the beginning end of another web and the trailing end through a slitting unit of a slitting machine.

15. The process of claim 13, further comprising:
slitting the joint along with the beginning end of another web and the trailing end in a slitting unit of a slitting machine.

16. The process of claim 10, wherein the attaching further comprises:
attaching a first end of the sealing element to the free end.

17. The process of claim 16, wherein the attaching further comprises:
attaching a second end of the sealing element to another portion of the outer layer.

18. The process of claim 10, further comprising:
forming another free end; and
attaching the other free end to the sealing element.

19. The process of claim 18, further comprising:
removing the sealing element from the pancake; and
reattaching the sealing element to the pancake.

20. A pancake of media in strip or tape form, comprising:
a roll of media that is wound to form an outer wound layer; and
a sealing element attached to the outer wound layer such that a free end of the outer wound layer is formed in a region beneath the sealing element.

21. A process for the production of a pancake of media in strip or tape form, the process comprising:
unwinding a first web of media;
guiding the first web of media over a cutting table;
connecting a trailing end of the first web of media to a beginning end of a second web of media to form a joint;
slitting the first and second webs and the joint in a slitting machine to form a plurality of individual strips; and
winding at least one of the plurality of strips to form the pancake,
wherein the sealing element is attached to the outer wound layer of the pancake such that a free end of the outer wound layer of the pancake is formed in a region beneath the sealing element.

22. The process of claim 21, wherein before the winding, the process further comprises:
spreading the plurality of strips in a spreader.

23. The process of claim 21, wherein before the slitting, the process further comprises:
securing to the cutting table at least the trailing end of the first web of media.

24. The process of claim 21, wherein before the slitting, the process further comprises:
securing to the cutting table the trailing end of the first web of media and the beginning end of the second web of media.
